(19) United States
(12) Patent Application Publication
(10) Pub. No.: US 2026/0086819 A1
(43) Pub. Date: Mar. 26, 2026

(54) PRE-RANKING OPTIMIZATION FOR MODEL-BASED MULTI-AGENT SYSTEMS

(71) Applicant: Dell Products L.P., Round Rock, TX (US)

(72) Inventors: Alisson Linhares de Carvalho, Aracaju (BR); Dilza de Mattos Szwarcman, Rio de Janeiro (BR); Vinicius Michel Gottin, Rio de Janeiro (BR)

(21) Appl. No.: 18/897,260

(22) Filed: Sep. 26, 2024

(51) Int. Cl. G06F 9/445; G06F 16/903

(52) U.S. Cl. CPC G06F 9/44505; G06F 16/90344

(57) ABSTRACT

A system or architecture for selecting, coordinating, and/or orchestrating multiple agents. Agent configurations are selected by extracting keywords from a command and searching a vector database of agent configurations. The closest agent configurations, based on a similarity measurement, are identified. Agents are initialized using the selected agent configurations and then instantiated. The orchestrator then plans and orchestrates execution of the command using the instantiated agents.

### TECHNOLOGICAL FIELD OF THE DISCLOSURE

Embodiments disclosed herein generally relate to artificial intelligence/machine learning (AI/ML) based multi-agent systems. More particularly, at least some embodiments relate to systems, hardware, software, computer-readable media, and methods for selecting, coordinating, and/or orchestrating the execution of tasks in multiple agent systems.

### BACKGROUND

In the context of artificial intelligence and computer science, an agent may be broadly defined as anything capable of perceiving its environment through sensors, reasoning on what was sensed, and performing actions through actuators. Agents are often configured to operate autonomously, make decisions, and take actions without user or human intervention.

Large language models (LLMs) have shown potential for being used as a controlling mechanism for autonomous intelligent agents. LLMs, for example, can help with several tasks, including planning and reflection. This may allow or enable new ways to interact with various systems to perform various tasks. However, general purpose agents face substantial challenges that need to be overcome before these interactions can be achieved.

A viable alternative is to use multiple specialized agents, rather than relying on a general purpose agent, to perform or solve tasks. These agents may operate more in conjunction with and/or in support of a user. Specialized agents can perform various tasks such as sending emails, searching for public information, and generating reports. However, a multiple agent approach to performing a task or set of tasks requires orchestration or management.

The number of specialized agents is likely to increase significantly in the near future. However, using multiple agents introduces a number of challenges. For example, orchestrating large numbers of agents may be computationally prohibitive. Keeping all agents instantiated may consume large amounts of computing resources (e.g., central/graphical processing units (CPU/GPU), memory, network). Further, LLMs are susceptible to hallucinations and orchestrating the execution of multiple agents increases this risk.

Reducing the number of agents to a static sub-set of agents is a sub-optimal solution at least because the best agent for a given task may not be included in the static sub-set of agents. Further, this type of static approach does not automatically change the composition of the set of agents, does not respond to changes in the availability of the agents and does not account for the facts that new agents may be deployed and that current agents may be retired (no-longer supported) or become outdated.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of an example agent;

FIG. 1B discloses aspects of input and output associated with an agent that uses or includes a large language model;

FIG. 2 discloses aspects of a multi-agent architecture;

FIG. 3 discloses additional aspects of a multi-agent system;

FIG. 4 discloses aspects of an agent configuration;

FIG. 5 discloses aspects of an agent builder configured to build agents based on agent configurations; and

FIG. 6 discloses aspects of a computing device, system, or entity.

### DETAILED DESCRIPTION OF SOME EXAMPLE EMBODIMENTS

Embodiments of the invention disclosed herein generally relate to multi-agent systems. More particularly, at least some embodiments relate to systems, hardware, software, computer-readable media, and methods for a multi-agent architecture configured to perform tasks by selecting, coordinating, and/or orchestrating agents.

Large language models (LLMs) can be configured to be the engine or brain of an agent, such as an autonomous intelligent agent. Embodiments of the invention relate to a architecture or system that allows for on-demand instantiation of agents based on a command to be executed/performed/solved. The command may be referred to as a task, job, request, mission, or the like and may be expressed in various forms and formats and may include or be divided into smaller commands. In contrast to conventional multi-agent systems, embodiments of the invention are relieved of the need to keep agents in concurrent execution, can dynamically determine or adapt a set of available agents for a command, and incorporate separately or independently developed agents.

In artificial intelligence and from a general perspective, an agent may be capable of receiving input via sensors, reasoning using the input, and taking actions. An autonomous agent may operate without human intervention. An agent that incorporates an LLM may be able to solve problems or perform commands in addition to simply generating text. In one example, the command may be a query or may be included in a query or other input received from a user or generated from other input.

Generally, embodiments of the invention relate to a multi-agent system that is configured to rank or select agents for a particular command. The command, or input to the system, is processed to identify keywords, which may be embedded, in one example. When the agents are represented in an embedded database, the keywords can be compared to the embeddings. This allows the agents that are closest or nearest (e.g., by cosine distance measurement) to the keywords (or task) to be selected and/or ranked. These agents are built and instantiated. Once the agents are instantiated, the orchestrator of the system can then orchestrate the execution of the command using the instantiated agents. The system may also determine the order in which the agents are executed.

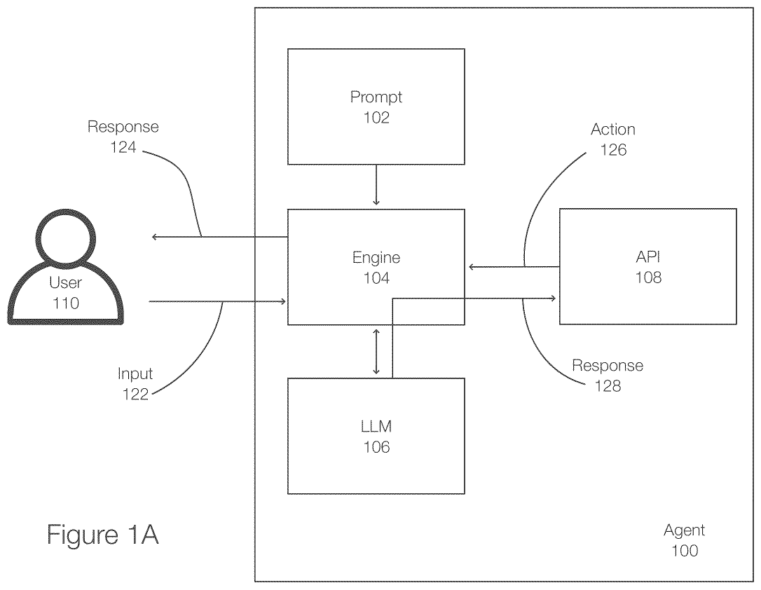

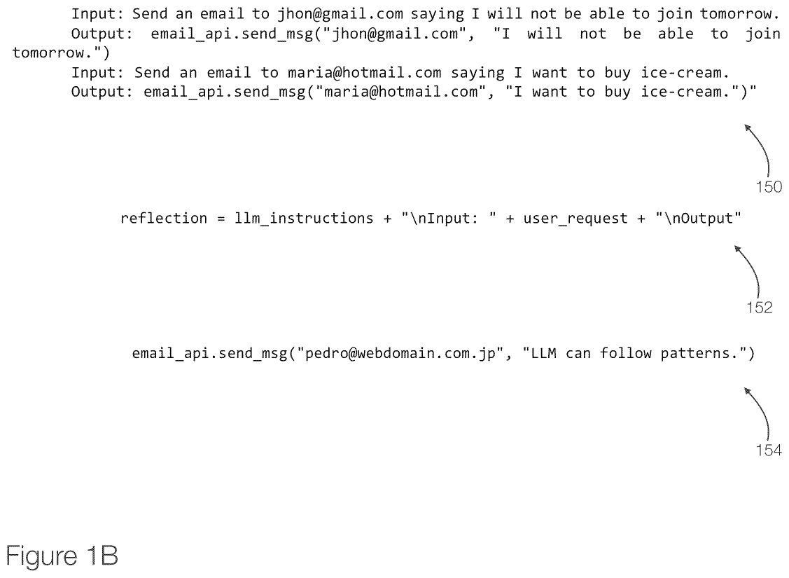

FIG. 1A discloses aspects of an example agent. The agent 100, by way of example, is an example of a tool agent that is a type of agent capable of interacting with applications using an application programming interface (API). In this example, the agent 100 includes (or has access to) a prompt 102, an engine 104, an LLM 106, and an API 108. In one example, the API 108 may be external to the agent 100 and may be associated with an application or other function.

The prompt 102, in one example, may determine or specify characteristics and capabilities of the agent 100, such as name, background, purpose, constraints, and rules to be followed during execution. In addition, the prompt 102 may include few-shot examples on how to use APIs, and/or templates for self-reflection and/or planning. The format of the prompt 102 depends on the technique used to implement the engine 104. The prompt 102 may be simple, with a few lines of text or complex text using formatted descriptions and snippets of code, which may be distributed across several different files.

In a tool agent, such as the agent 100, the engine 104 is a component or module that connects a user's intention (e.g., the command or input 122 received from the user 110) to a sequence of API executions. The configuration and capabilities of the engine 104 may vary. For example, the engine 104 may be implemented as a text-to-function map, use self-reflection, perform planning, task prioritization and decomposition, and provide memory, execution history, and learning capabilities.

For example, using a few-shot implementation in the prompt 102, the prompt 102 may provide a brief description of an API and examples of how to use the API. Based on the examples, the engine 104 may use the LLM 106 to map the input 112 received from the user 110 (or other source) to parameters of the functions of the APIs to be accessed.

For example, the agent 100 may be configured as a specialized agent capable of sending emails based on generic orders. In this case, examples of the prompt used to feed the LLM 106 may be the engine 104 are illustrated in FIG. 1B.

FIG. 1B illustrates examples of input and output associated with an agent using an LLM. The prompt 150, which is an example of the prompt 102, illustrates the input and output of the LLM 106 in the context of an agent configured to send an email based on user input. The instructions or text included in the prompt 150 describe how to map an input to a function. The instructions (e.g., few-shots) in the prompt 150 can be used as a reference and the LLM 106 may follow the same response behavior for every command provided by the user 110.

For the agent 100 in FIG. 1A, the engine 104 may concatenate the command (e.g., the mission or input 122) with the LLM instruction in the prompt 150 as illustrated at the reflection prompt 152, which may be input to the LLM.

The response 154 of the LLM may be a command that can be submitted to an API 108. Thus, the code generated by the LLM 106 (the response 154) may be executed by calling the API 108 using the response 154.

Returning to FIG. 1A, a user 110 may provide an input 122 (e.g., command) as input to an engine 104. The input 122 may be text, sound, image, or the like or combinations thereof. The input 122 and the prompt 102 are used to generate a model prompt (e.g., a reflection prompt) to the LLM 106. The response 128 from the LLM 106 may be formatted appropriately (e.g., as a function call) to be passed to the API 108. For example, an autoexec routine within a sandbox may be used to run the code (the response 128) generated by the LLM 106. The API 108 may be associated with an application that performs an action 126 based on the response 128 from the LLM 106 and the engine 104 may provide a response 124 (e.g., an alert or other notification) to the user. For example, the response 124 may be a result of the command or a notification that the command is completed (e.g., email has been sent).

This example is discussed in the context of an agent with a prompt that includes few-shot examples. However, the prompt 102 may be more complex. For example, the engine 104 may include reasoning and acting (ReACT), where the engine 104 is implemented using a loop of reflection and action. The agent 100 may attempt, in this example, to analyze various alternatives to reach the goal. The engine 104 may also interact with the user 110 in order to aid in completing the task being performed.

The performance of the engine 104 may depend or be impacted by the quality and tuning characteristics of the LLM 106. For example, text completion and instruct LLMs are less prone to fail the user's command than a chat-based LLM. Usually, during the fine-tuning, the LLM can be forced to give responses like ‘I am an AI model unable to connect to the internet.’ This kind of tuning can break the reflection loop. Therefore, the selection of the LLM for the agent 100 may impact the performance of the agent 100.

In another example, the LLM 106 may be configured to describe the execution order of functions. More specifically in one example, the command or input 122 may be combined with a description of an API. This may allow the LLM 106 to detect the parameters and generate the code necessary to invoke the APIs or functions in the appropriate order.

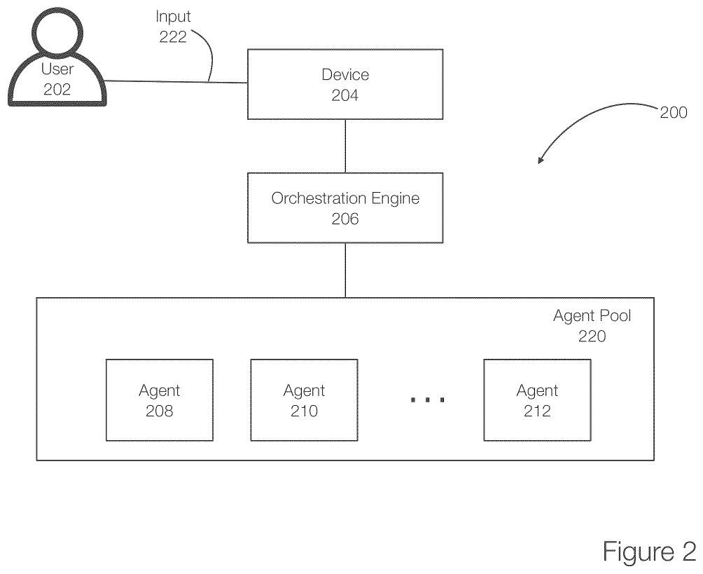

FIG. 2 discloses aspects of a multi-agent architecture. A multi-agent system (MAS) extends the concepts of individual agents by considering a collection of multiple agents. In an MAS, multiple agents may coexist in a computing environment or a computing system and each of the agents may be associated with its own sensors and actuators (or input/output). Agents in a MAS can act independently, cooperatively, sequentially, in parallel, or the like or combinations thereof. In one example, the agents can each pursue individual goals or cooperate to achieve a collective goal. One benefit of multiple agents is the ability to perform or solve commands that a single agent may not be able to perform or solve. Embodiments of the invention improve this architecture by determining which of the agents to instantiate. This avoids the need to maintain instantiated agents and conserves computing resources.

Generally, an MAS may adopt various paradigms. For instance, in a cooperative paradigm, agents work together toward common goals or objectives. These agents may exchange information to improve collective solutions. In a debate paradigm, agents may engage in argumentative interactions, presenting and defending their viewpoints while critiquing the viewpoints of other agents. The debate paradigm is effective for reaching consensus or refining the solutions.

In FIG. 2, a user 202 may submit an input 222 (e.g., command) into a device 204, which may be a computing device. The device 204 may coordinate with an orchestration engine 206. The orchestration engine 206 may be a server computer or system and may be cloud-based, edge-based, or the like. The orchestration engine 206 may be integrated with the device 204. For example, a user may access the MAS via a browser or the like.

The orchestration engine 206 may be associated with an agent pool 220 represented by agents 208, 210, and 212, which are examples of the agent 100. In this example, the agent pool 220 may represent agents that are not instantiated and the orchestration engine 206 may identify specific agents to instantiate using the input 222.

In operation, the input 222 is received by the orchestration engine 206 and the orchestration engine 206 selects agents from the agent pool 220, instantiates the selected agents, and orchestrates execution or performance of the input 222.

Embodiments of the invention includes aspects of selecting agents. Selecting agents may include various aspects that include agent instantiation, agent building, agent ranking, agent evaluation, or the like.

The MAS 200 may be implemented using contract net protocol, which establishes a bidding process where the agents compete for tasks by submitting bids and the agent with the best bid is awarded the task. The MAS 200 may be implemented using a Belief-Desire-Intention (BDI) architecture, which models agents based on their beliefs about the world, desires to achieve certain goals, and intentions to perform certain actions. BDI allows agents to reason about their actions and make decisions in complex, dynamic environments. Another approach includes role-based coordination where agents assume specific roles within a system, and communication and coordination are structured around these roles. This helps to organize and simplify the interaction patterns between agents, making the system more scalable and modular.

Game theory may be used to model interactions between rational, self-interested agents. Game theory provides a framework for analyzing strategic interactions and making decisions in competitive or cooperative environments. In addition, consensus algorithms, such as the Consensus-Based Bundle Algorithm, aim to synchronize the decisions of agents in a distributed manner. These algorithms are useful when agents need to agree on a common course of action or plan. The use of consensus ensures that the distributed system converges to a consistent state. Other approaches include swarm intelligence, where a large number of simple agents can cooperate to accomplish complex tasks, and holon agent, which exhibit both individual autonomy and the ability to cooperate with other agents to achieve common goals (HMAS).

Aspects of performing tasks in MAS systems include performing searches of various types. Unlike traditional relational databases, which are optimized for storing and querying structured data in tables, vector databases are designed to efficiently handle high-dimensional data points represented as vectors. They often employ specialized indexing and querying techniques tailored to the characteristics of vector data, enabling fast and scalable retrieval of relevant information from large datasets.

This type of database is useful for tasks such as similarity searches, nearest neighbor searches, clustering, and classification, where the relationships between data points are based on their proximity or similarity in the vector space.

Embodiments of the invention may employ a vector database to store embeddings of textual agent configurations. Each embedding may function as an index to the original configuration file. This allows a similarity search to be used to retrieve the k agent configurations that are most similar to a specific query or specific input.

For example, a database of agents may be selected or imported, along with relevant libraries into a system. Next, a document (e.g., file or agent configuration) may be accessed or loaded into memory. Once loaded, the document may be processed to split the text of the document into chunks. Each chunk may be embedded and stored in an agent configuration database. In one example, the all-MiniLM-L6-v2 model is used for embedding. In one example, the vector database may use a Chroma DB.

Once the agent configuration database is prepared, a similarity strategy may be employed to search for documents whose content is close to a query input. The result of the similarity search may be a list of k documents or k agent configurations, where the 0^{th} document is the most similar document to a sentence (or query), and k is the least similar document among the selected documents.

Metadata, such as information about the file, can be added to each document or agent configuration. In addition, several files may be merged into a single database and a similarity search can be employed to retrieve not only the content but also the files.

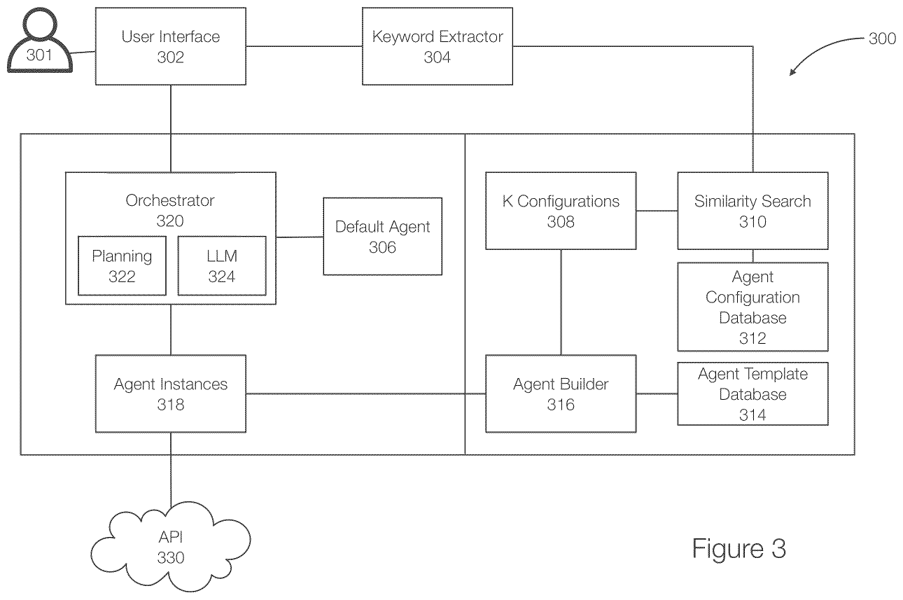

FIG. 3 discloses aspects of an example architecture for managing (e.g., coordinating, selecting, orchestrating) agents. FIG. 3 further illustrates an example method for orchestrating a command in a multi-agent system. Generally, a large number of different agents may be available in the multi-agent system and each agent is associated with a specific agent configuration and a description that describes the operation of the corresponding agent (the description may be included in the agent configuration). The metadata may have various forms such a general key-value schema.

In the system 300, a user interface 302 may allow a user 301 to generate and submit input such as a command. The input may be processed by a keyword extractor 304, which may be based on or use a large language model. The system also includes an orchestrator 320 and an agent builder 316.

Once keywords are extracted (and/or embedded) by the keyword extractor 304, a similarity search 310 may be performed using the extracted keywords. The similarity search 310 may rely on a vector database that stores embeddings corresponding to the agent configurations. Thus, the agent configuration database 312 represents the database of embeddings in one example. The agent configuration database 312 may include metadata that guides the instantiation of the agent may include or contain a prompt with directives on how the agent operates. The agent configurations in the agent configuration database 312 may also include examples (e.g., few shots) or code that are used to guide the keyword extractor 304.

In some examples, LLM based agents may use read-only instructions to configure the agent's engine or brain. As a result, a template of each agent in a text format can be stored in the agent configuration database 312. The descriptions of the agents may be used as an index for retrieval.

In one example, the agent configuration database 312 allow agents to perform a command to be identified and selected and instantiated in real time or near real time.

In one example, the system 300 is prepared to perform commands once the agent configurations 312 are selected and the agents are instantiated. More specifically, the system may identify or determine the agents to perform, execute, or solve a current command received by the system 300. In one example, an input (the command) is received at the orchestrator 320 from the user 310 via a user interface 302. The input is parsed and provided to the keyword extractor 304. The keyword extractor generates a set of keywords. The keyword extractor 304 may be or include an LLM. The LLM may be prompt-guided and/or fine-tuned for extracting keywords.

The keywords identified by the keyword extractor 304 are input to a similarity search 310. The similarity search 310 may compare the keywords to the agent configuration stored in the agent configuration database 312. In one example, the similarity search 310 determines or identifies the k most similar or relevant candidate agents. The k most similar agents are based on the similarity of the descriptions in the agent configurations 312 to the extracted keywords in one example.

The agent configurations identified by the similarity search 310 are provided to the agent builder 316. The agent builder 316 provides or builds, for each of the candidate agents, an agent instance. Thus, the agent instances 318 are generated or built by the agent builder 316. More specifically, the agent builder 316 generates an agent instance by imprinting the candidate agent configuration into a template from a database of agent templates 314. The agent templates stored in the agent template database 314 typically defines the implementation technique.

The orchestrator 320 communicates with the agent instances 318 to accomplish the command and may rely on its own modules such as an LLM 324 and planning 322.

If the orchestrator 320 is unable to leverage the agent instances 318 into accomplishing the command in the input received via the user interface 302, the orchestrator 320 may rely on a default agent 306, such as a conversational agent, to obtain more information from the user 310 or to explain the shortcomings of the currently available tools or agents.

Otherwise, the orchestrator 320 effects a plan, using the planning module 322, the orchestrator 320 performed by the plan by executing the agent instances 318 in an appropriate order. Each of the agent instances 318 may call an API (e.g., the API 330 or other API) as needed.

In one example, the orchestrator 320 may interact with a limited number of agent instances at least because only k agents were identified. As a result, the likelihood of error/hallucination is reduced. This improves the process of performing a task or mission in a multi-agent system.

Advantageously, embodiments of the invention can dynamically change and/or adapt to the availability of agents. For example, new implementations of agents added to the system 300 can be defined and added to the template database 314, and different agent configurations for the same implementation can be defined and added to the configuration database 312 without changing the agent implementation stored in the template database 314. Deprecated agents can be removed from the agent configuration database 312. This is an improvement compared to centralized and hierarchical techniques that struggle with scaling as the number of agents increases.

Embodiments of the invention pre-rank agents before the agents are available for mission execution. This ensures that only agents capable of addressing or solving the mission are scaled by the orchestrator 320. The ranking, in one example, is reflected in the similarity search, which the k most similar agent configurations are identified.

Embodiments of the invention thus relate to a multi-agent architecture or system configured to select, configure, and/or orchestrate large numbers of agents.

In more detail, the system 300 may include a user interface that allows user interaction. Thus, the user 301 may provide a command (input, mission, order) to the orchestrator 320. The command may include images, text, audio, etc. The type of interface is not constrained. In one example, however, the command, regardless of format, may be converted to a text prompt that describes the mission to be performed or accomplished. Thus, the user interface 302 may include a module to convert the input to a text prompt. The text prompt is provided as input to the keyword extractor 304 and to the orchestrator 320.

The keyword extractor 304 extracts a set of keywords from the text prompt. The keyword extractor 304 may be implemented in several ways including an LLM that is prompted or fine-tuned. In one example, KeyBART is used.

When the keyword extractor 304 includes or uses an LLM, other mechanisms or features may be allowed to further improve performance. For instance, a user-specific history may be provided for keyword extraction.

The keywords extracted from the from the user query/mission are compared to the agent configurations in the agent configuration dataset 312. The database 312 stores, in one example, metadata and descriptions related to the operation of the corresponding agent. The keywords may be embedded in order to compare to embedded agent configurations.

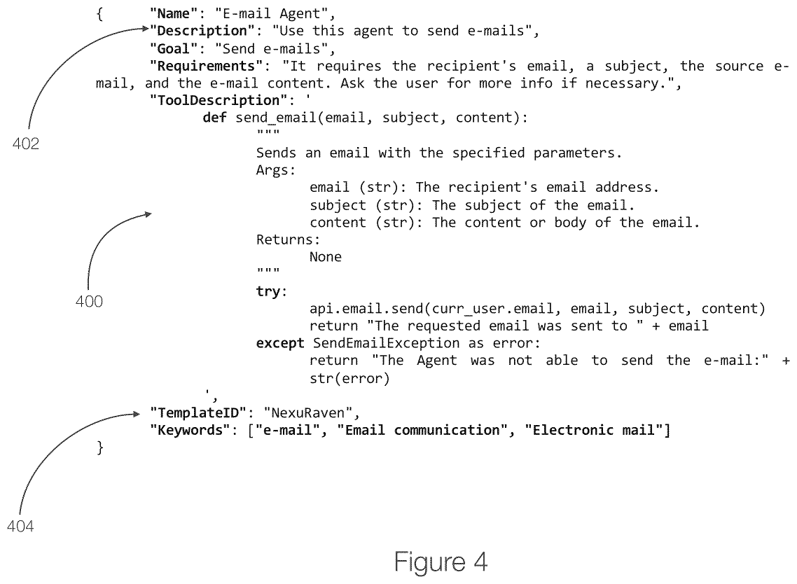

FIG. 4 illustrates an example of a description of an agent. FIG. 4 more specifically illustrates an example of a description of an agent configured to send emails. The agent configuration 400 illustrates both a description of the agent and example keywords. Thus, a user command to send an email communication to a designated recipient may have terms, such as email (or e-mail), and send, extracted from the command. These may be matched or compared to the description 402 and other text in the agent configurations stored in the agent configuration database 312.

In one example, a simple key-value format is adapted for the database 312, but other implementations may be used. However, regardless of the format or storage technology, the agent configuration database 312 is configured to store or hold multiple entries (multiple agent configurations), each including sufficient information for instantiating an agent.

In this example of FIG. 4, a name of the agent, a description of the agent, a goal of the agent, requirements of the agent, and keywords are provided in the configuration 400. The configuration 400 also defines tools in a tool description. This example defines a single tool and provides codes (e.g., Python code) for the execution. This schema of an example agent configuration illustrated in FIG. 4 is an example and may allow an agent configuration to define an array of tools of multiple types, including web services, precompiled code, and the like.

The configuration 400 also includes a template identifier 404. The template identifier 404 may be used by the agent builder 316 to identify an agent template from the agent template database 314.

The similarity search 310 of the agent configurations stored in the agent configuration database 312 may be performed using the extracted keywords. As previously indicated, the database 312 may be a vector database that is instantiated and populated with the embeddings of the textual fields in the agent configurations. These fields include the descriptive field (e.g., name, description, goal, requirements, etc) and may also include other metadata such as the keywords 404 and relevant data from the tools in the tool description. If the tools of the agent are services, the description of the endpoints accessed can be used. More broadly, text data and metadata in the configuration 400 may be used during the similarity search 310 and stored in the embeddings of the database 312.

The similarity search is performed to identify the k most similar agent configurations by encoding or embedding the search keywords (provided by the keyword extractor 304) and determining a similarity measure (e.g., cosine similarity) between the encoded keywords and the agent configurations stored in the database 312.

Also, in the context of vector database approaches, a chunking strategy may be performed depending on the size of the agent configurations stored in the database 312.

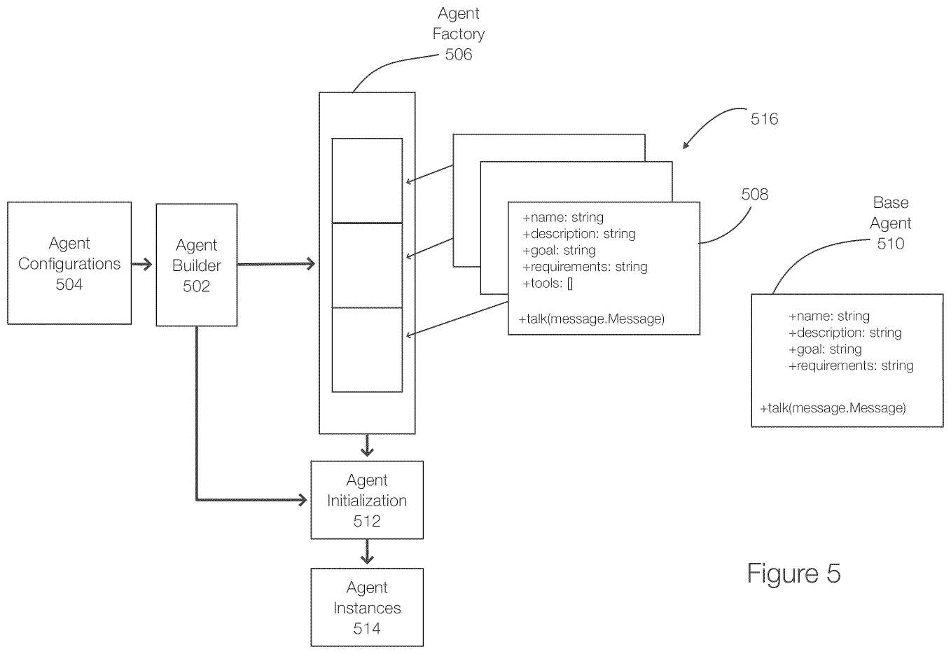

FIG. 5 discloses aspects of a pipeline associated with an agent builder. The agent builder 502 is typically responsible for generating agent instances, such as agent instances 514, based on agent configurations, such as the agent configurations 504.

More specifically, the agent builder 502 may map agent configurations 504 to respective agent templates using the template identifiers included in the agent configurations. Thus, an agent factory 506 may collect the agent templates 516, such as the agent template 508. The agent factory 506 may include an agent template for each of the agent configurations in the agent configurations 504.

In one example, each agent template implements a common interface known to the orchestrator 320. In one example, the common interface is represented by the base agent 510. Thus, each of the agent template implements the same or similar interface as the base agent 510. In this example, a talk function is provided that is included in each of the agent templates 516, which is also included in the base agent 510. The talk function may be used by the orchestrator to communicate with the agent.

Each of the agent instances 514 typically have different characteristics and requirements. Some may require the use of a specific LLM (e.g., NexusAgent) or require a more sophisticated prompt pattern. Notwithstanding the use of the base agent 510, the agent templates are associated with agent configuration files that are changeable and specific to each type of agent template. Example agent templates include, by way of example only NexusAgent, ReActAgent, and RLPAgent.

The use of a common and standardized interface significantly increases code reuse, as the same type of agent can be used by hundreds or even thousands of different configurations. Additionally, an update in an agent template allows all agents to automatically benefit from the improvements without requiring the agents to be rebuilt.

Separating configurations from implementations allows for greater flexibility. Further, a final user does not need in-depth knowledge of programming to create new agents, but only needs to know the format of each agent's configuration file and write compatible text using the agent template.

The agent builder 502 is thus responsible for instantiating agents based on agent configurations that were identified from the similarity search. In one example, the agent builder 502 may employ a factory design pattern or agent factory 506 where the template identifier (TemplateID) is used as an index to search for the agent templates 516 compatible with the received agent configuration 504.

Some fields from the agent configurations 504, which may be a config JSON, are shared by all agent templates. These fields may include Name, Description, Objectives, Requirements, and TemplateID. In FIG. 5, the agent templates 516 may represent, by way of example only, NexusAgent, ReActAgent, RLPAgent, and ChatAgent templates. These agent templates are classes that implement the interface illustrated by the base agent 510. For each agent configuration received by the agent builder 502, the Template identifier field is used as an index to search for the appropriate agent template.

Once the agent templates for the agent configurations 504 are identified, the agent templates are initialized (agent initialization 512) with the remaining fields extracted from the agent configuration, such as Name, Description, Goal, Requirements, and Tools. Thus, the agent templates 516 are imprinted using the agent configurations 504. The agents are instantiated (agent instances 514). Using the talk function, for example, the orchestrator can communicate with each instantiated agent.

Embodiments of the invention provide flexibility and can work with third-party agents. In one example, a bypass tool agent, where the talk function is a wrapper for an API from a different source, may be used. This allows the multi-agent system to connect to any application or source by writing a configuration script compatible with the bypass tool agent.

In addition, selecting the agent templates can be done in several ways, such as using a switch case or even a dictionary of templates. The choice of data structure, methodology used and extensions to this base design may depend on the number of agent templates that will be supported by the architecture.

In one example, the orchestrator 320 is an LLM-based orchestrator with planning capabilities as illustrated by the planning 322. Thus, the orchestrator 320 may include or be associated with planning 322 and an LLM 324. The orchestrator 320 receives the input from the user 301 and breaks the tasks or mission represented by the input into specific tasks. This process may include considering contextual and/or historical information. The orchestrator 320 then generates a plan, which is a sequence of operations to achieve the mission represented by the input. The orchestrator 320 then performs the plan by selecting, based on the available agent instances 318, which of the agent instances should be executed at a given point of task execution.

The orchestrator 320 may itself be implemented as an agent that is able to communicate directly with selected agents to determine which is the best suited for executing a task. The default agent 306 may be configured to obtain outputs (e.g., in a conversational manner) that may be useful in the event that information is missing, the plan is invalid, or communications issues with the agent instances cause the plan to fail. The default agent 306 may also be responsible for consolidating and summarizing the results obtained from the agents invoked in executing the plan.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, machine learning related operations, multi-agent system operations, multi-agent selection, coordination, and/or orchestration operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a command from a user via a user interface, performing a similarity search in an agent configuration database based on the command to identify candidate agent configurations similar to the command, identifying agent templates based on identifiers associated with the candidate agent configurations, initializing an agent for each of the candidate agent configurations using the corresponding agent templates and the corresponding agent configurations, instantiating the agent for each of the candidate agents, and performing the command using the instantiated agents.

Embodiment 2. The method of embodiment 1, further comprising extracting keywords from the command.

Embodiment 3. The method of embodiment 1 and/or 2, further comprising performing the similarity search using the keywords extracted from the command, wherein the candidate agent configurations include a k most agent configurations nearest to the extracted keywords based on a similarity measure.

Embodiment 4. The method of embodiment 1, 2, and/or 3, further comprising imprinting each of the identified candidate agent configurations onto the corresponding agent templates.

Embodiment 5. The method of embodiment 1, 2, 3, and/or 4, wherein each of the agent templates include a talk function for communicating with an orchestrator configured to orchestrate the command with the instantiated agents.

Embodiment 6. The method of embodiment 1, 2, 3, 4, and/or 5, wherein imprinting each of the identified candidate agents includes importing one or more of a name, a description, a tool, and a goal into the corresponding agent template.

Embodiment 7. The method of embodiment 1, 2, 3, 4, 5, and/or 6, wherein each of the instantiated agents includes a prompt, a large language model, and an engine.

Embodiment 8.The method of embodiment 1, 2, 3, 4, 5, 6, and/or 7, wherein the command includes one or more of text, an image, audio, further comprising converting the text to a text prompt that describes a mission represented in the command.

Embodiment 9.The method of embodiment 1, 2, 3, 4, 5, 6, 7, and/or 8, wherein an orchestrator is configured to orchestrate execution of the command using the instantiated agents, further comprising communicating with a user using a default agent to obtain more information when the command cannot be performed or execution of the command fails.

Embodiment 10. The method of embodiment 1, 2, 3, 4, 5, 6, 7, 8, and/or 9, further comprising generating a plan by an orchestrator based on the command, wherein the plan includes an order in which one or more of the instantiated agents are executed.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example,

instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

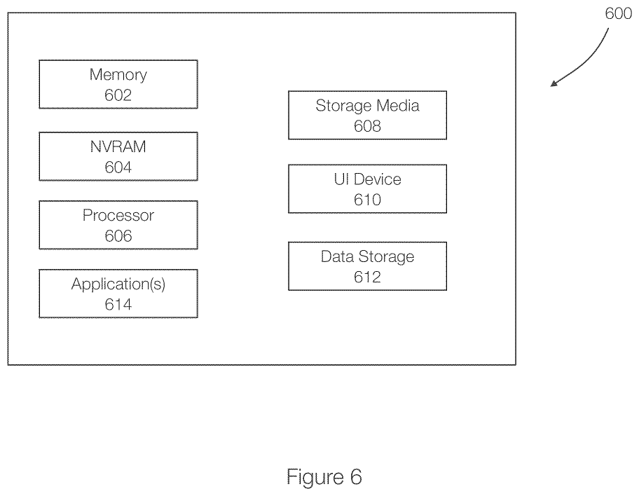

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

The device 600 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 600 may also represent a physical or virtual machine or server, an edge-based computing system, a cloud-based computing system, server clusters or other computing systems or environments. The device 600 may also represent multiple machines or devices, whether virtual, containerized, or physical. The device 600 may perform or execute steps or acts of the methods illustrated in the Figures.

The described embodiments are to be considered in all respects only as illustrative and not restrictive. All changes which come within the meaning and range of equivalency of the claims are to be embraced within their scope.

What is claimed is:

1. A method comprising:
receiving a command from a user via a user interface;
performing a similarity search in an agent configuration database based on the command to identify candidate agent configurations similar to the command;
identifying one or more agent templates based on identifiers associated with the candidate agent configurations;
initializing an agent for each of the one or more candidate agent configurations using corresponding agent templates and the corresponding agent configurations;
instantiating the agent for each of the candidate agents;
performing the command using the instantiated agents.

2. The method of claim 1, further comprising extracting keywords from the command.

3. The method of claim 2, further comprising performing the similarity search using the keywords extracted from the command, wherein the candidate agent configurations include a k most agent configurations nearest to the extracted keywords based on a similarity measure.

4. The method of claim 1, further comprising imprinting each of the identified candidate agent configurations onto the corresponding agent templates.

5. The method of claim 4, wherein each of the agent templates include a talk function for communicating with an orchestrator configured to orchestrate the command with the instantiated agents.

6. The method of claim 4, wherein imprinting each of the identified candidate agents includes importing one or more of a name, a description, a tool, and a goal into the corresponding agent template.

7. The method of claim 1, wherein each of the instantiated agents includes a prompt, a large language model, and an engine.

8. The method of claim 7, wherein the command includes one or more of text, an image, audio, further comprising converting the text to a text prompt that describes a mission represented in the command.

9. The method of claim 8, wherein an orchestrator is configured to orchestrate execution of the command using the instantiated agents, further comprising communicating with a user using a default agent to obtain more information when the command cannot be performed or execution of the command fails.

10. The method of claim 1, further comprising generating a plan by an orchestrator based on the command, wherein the plan includes one or more orders in which one or more of the instantiated agents can be executed.

11. A non-transitory storage medium having stored therein instructions that are executable by one or more hardware processors to perform operations comprising:
receiving a command from a user via a user interface;
performing a similarity search in an agent configuration database based on the command to identify candidate agent configurations similar to the command;
identifying agent templates based on identifiers associated with the candidate agent configurations;
initializing an agent for each of the candidate agent configurations using corresponding agent templates and the corresponding agent configurations;
instantiating the agent for each of the candidate agents;
performing the command using the instantiated agents.

12. The non-transitory storage medium of claim 11, further comprising extracting keywords from the command.

13. The non-transitory storage medium of claim 12, further comprising performing the similarity search using the keywords extracted from the command, wherein the candidate agent configurations include a k most agent configurations nearest to the extracted keywords based on a similarity measure.

14. The non-transitory storage medium of claim 11, further comprising imprinting each of the identified candidate agent configurations onto the corresponding agent templates.

15. The non-transitory storage medium of claim 14, wherein each of the agent templates include a talk function for communicating with an orchestrator configured to orchestrate the command with the instantiated agents.

16. The non-transitory storage medium of claim 14, wherein imprinting each of the identified candidate agents includes importing one or more of a name, a description, a tool, and a goal into the corresponding agent template.

17. The non-transitory storage medium of claim 11, wherein each of the instantiated agents includes a prompt, a large language model, and an engine.

18. The non-transitory storage medium of claim 17, wherein the command includes one or more of text, an image, audio, further comprising converting the text to a text prompt that describes a mission represented in the command.

19. The non-transitory storage medium of claim 18, wherein an orchestrator is configured to orchestrate execution of the command using the instantiated agents, further comprising communicating with a user using a default agent to obtain more information when the command cannot be performed or execution of the command fails.

20. The non-transitory storage medium of claim 11, further comprising generating a plan by an orchestrator based on the command, wherein the plan includes on or more orders in which one or more of the instantiated agents can be executed.
